(19) United States
(12) Patent Application Publication
(10) Pub. No.: US 2010/0036008 A1
(43) Pub. Date: Feb. 11, 2010

(54) HIGHLY ELASTIC FLEXIBLE POLYURETHANE FOAMS

(75) Inventors: Bernd Bruchmann, Freinsheim (DE); Daniel Schoenfelder, Mannheim (DE); Andrea Eisenhardt, Vechta (DE); Markus Schuette, Osnabrueck (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/518,668

(22) PCT Filed: Dec. 6, 2007
(86) PCT No.: PCT/EP07/63445

§ 371 Date: Jun. 11, 2009

(30) Foreign Application Priority Data
Dec. 11, 2006 (EP) 06125824.0

(51) Int. Cl. C08L 75/00

(52) U.S. Cl. 521/137; 521/172

(57) ABSTRACT

The present invention relates to a highly elastic flexible polyurethane foam obtainable by mixing a) polyisocyanate with b) at least one relatively high molecular weight compound having at least two reactive hydrogen atoms, c) hyperbranched polyester c1) of the AₓB_{y} type, where x is at least 1.1 and y is at least 2.1, and/or hyperbranched poly-carbonate c2), d) if appropriate, low molecular weight chain extender and/or crosslinker, e) catalyst, f) blowing agent and g) if appropriate other additives. The present invention further relates to a process for producing such a flexible polyurethane foam and the use of the flexible polyurethane foam of the invention for producing furniture, mattresses, orthopedic products, car seats and other upholstery in the automobile sector.

The present invention relates to highly elastic flexible polyurethane foams obtainable by mixing a) polyisocyanate with b) at least one relatively high molecular weight compound having at least two reactive hydrogen atoms, c) hyperbranched polyester c1) of the AₓB_{y} type, where x is at least 1.1 and y is at least 2.1, and/or hyperbranched polycarbonate c2), d) if appropriate, low molecular weight chain extender and/or crosslinker, e) catalyst, f) blowing agent and g) if appropriate other additives, a process for producing them and their use for producing furniture, mattresses, automobile seats and other upholstery in the automobile sector.

Further embodiments of the present invention may be found in the claims, the description and the examples. It goes without saying that the abovementioned features and the features still to be explained below of the subject matter of the invention can be used not only in the combination indicated in each case but also in other combinations without going outside the scope of the invention.

Flexible polyurethane foams are used predominantly for the production of furniture and mattresses and for automobile seats and automobile carpets. Important properties for these applications are mechanical and mechanodynamic parameters such as hardness, elasticity, elongation, tensile strength, loss modulus and storage modulus. As regards the hardness and the elasticity of flexible polyurethane foams, it is generally the case that an increase in the elasticity leads to a decrease in the hardness.

For most applications, for example upholstery for seats or mattresses, there are fixed hardness requirements. However, a particular comfort feature of flexible polyurethane foams is a very high elasticity.

A further important parameter for flexible polyurethane foams is their density. Efforts are made to reduce the density for cost and weight reasons, so as to use as little material as possible. However, a reduction in the density at a constant hardness leads to a reduction in the elasticity.

A further comfort feature for polyurethane foams, in particular when they are used as automobile seats, is vibration damping.

It is known from WO 03/062297 that dendritic polyethers can be used for producing polyurethane foams and lead to improved foam stability at low density and high compressive strength.

It is known from WO 02/10247 that a dendritic polyester can be used as additive in order to increase the hardness and the pressure stability of isocyanate-based polymer foams at a constant density. The dendritic polymer can be any type of dendritic polymer which has a content of active hydrogen atoms of greater than 3.8 mmol/g and an OH functionality of greater than 8 and is miscible to an extent of at least 15% by weight, based on the weight of the dendritic polymer, with a polyetherol having an OH number of less than 40.

A disadvantage of the known dendritic and hyperbranched additives of the prior art is that these additives lead to predominantly closed-celled polyurethane foams. However, closed-celled polyurethane foams have a reduced elasticity compared to open-celled foams. Furthermore, the processing of closed-celled flexible polyurethane foams is difficult since the cell gases comprised in the cells contract after the reaction due to cooling of the foam, which leads to undesirable shrinkage of the polyurethane foams. Although it is possible to keep the cells of the resulting polyurethane foam open by means of further additives, for example surfactants, these additives are expensive and lead to poorer mechanical properties of the foam. Furthermore, these polyurethane foams can be produced only when specific isocyanates and additives are used, since otherwise incompatibilities occur and lead to occurrence of foam defects or make the foam impossible to produce.

It was therefore an object of the present invention to provide polyurethane foams which have a high hardness and nevertheless a high elasticity.

A further object of the present invention was to provide polyurethane foams which display a wide processing range and can be produced as flexible slabstock foams or molded foams.

Finally, it was an object of the invention to provide polyurethane foams having high comfort properties in the form of damping properties, for example a low transmission (vibration damping) at the resonance frequency.

For the purposes of the invention, flexible polyurethane foams comprise all known polyisocyanate polyaddition products which are foams in accordance with DIN 7726 and have a compressive stress at 10% deformation or compressive strength in accordance with DIN 53 421/DIN EN ISO 604 of 15 kPa and less, preferably from 1 to 14 kPa and in particular from 4 to 14 kPa. Flexible polyurethane foams according to the invention preferably have a proportion of open cells in accordance with DIN ISO 4590 of greater than 85%, particularly preferably greater than 90%.

To produce the elastic flexible polyurethane foams of the invention, a) polyisocyanate is mixed with b) at least one relatively high molecular weight compound having at least two reactive hydrogen atoms, c) hyperbranched polyester c1) of the AₓB_{y} type, where x is at least 1.1 and y is at least 2.1, and/or hyperbranched polycarbonate c2), d) if appropriate, low molecular weight chain extender and/or crosslinker, e) catalyst, f) blowing agent and g) if appropriate other additives to form a reaction mixture and the reaction mixture is cured to give the flexible polyurethane foam.

The polyisocyanate component (a) used for producing the composites according to the invention comprises all polyisocyanates known for producing polyurethanes. These comprise the aliphatic, cycloaliphatic and aromatic bifunctional or polyfunctional isocyanates known from the prior art and also any mixtures thereof. Examples are diphenylmethane 2,2′-, 2,4′- and 4,4′-diisocyanate, the mixtures of monomeric diphenylmethane diisocyanates and homologues of diphenylmethane diisocyanate having more than two rings (polymeric MDI), isophorone diisocyanate (IPDI) or its oligomers, tolylene 2,4- or 2,6-diisocyanate (TDI) or mixtures thereof, tetramethylene diisocyanate or its oligomers, hexamethylene diisocyanate (HDI) or its oligomers, naphthylene diisocyanate (NDI) or mixtures thereof.

Preference is given to using diphenylmethane 2,2′-, 2,4′- and 4,4′-diisocyanate, the mixtures of monomeric diphenylmethane diisocyanates and homologues of diphenylmethane diisocyanate having more than two rings (polymeric MDI), tolylene 2,4- or 2,6-diisocyanate (TDI) or mixtures thereof, isophorone diisocyanate (IPDI) or its oligomers, hexamethylene diisocyanate (HDI) or its oligomers, or mixtures of the known isocyanates. The isocyanates which are preferably used can also comprise uretdione, allophanate, uretonimine, urea, biuret, isocyanurate or iminooxadiazinetrione groups. Further possible isocyanates are given, for example, in “Kunststoffhandbuch, volume 7, Polyurethane”, Carl Hanser Verlag, 3rd edition 1993, chapters 3.2 and 3.3.2.

As an alternative, the polyisocyanate (a) is used in the form of polyisocyanate prepolymers. These polyisocyanate prepolymers are obtainable by reacting polyisocyanates (a-1) described above with polyols (a-2), for example at temperatures of from 30 to 100° C., preferably at about 80° C., to form the prepolymer. The prepolymers according to the invention are preferably prepared using polyols based on polyesters, for example ones derived from adipic acid, or polyethers, for example ones derived from ethylene oxide and/or propylene oxide.

Polyols (a-2) are known to those skilled in the art and are described, for example in “Kunststoffhandbuch, 7, Polyurethane”, Carl Hanser Verlag, 3rd edition 1993, chapter 3.1. Preference is given to using relatively high molecular weight compounds having at least two reactive hydrogen atoms as described under (b) as polyols (a-2).

In one embodiment, hyperbranched polyester c1) of the AₓB_{y} type, where x is at least 1.1 and y is at least 2.1, and/or hyperbranched polycarbonate c2), having hydrogen atoms which are reactive toward isocyanates can also be used as constituent (a2) for preparing the prepolymer.

If appropriate, chain extenders (a-3) can be added to the reaction to form the polyisocyanate prepolymer. Suitable chain extenders (a-3) for the prepolymer are dihydric or trihydric alcohols, for example dipropylene glycol and/or tri propylene glycol, or adducts of dipropylene glycol and/or tripropylene glycol with alkylene oxides, preferably propylene oxide.

As relatively high molecular weight compound having at least two reactive hydrogen atoms (b), use is made of the compounds which are known and customary for producing flexible polyurethane foams.

Preferred compounds having at least two active hydrogen atoms (b) are polyester alcohols and/or polyether alcohols having a functionality of from 2 to 8, in particular from 2 to 6, preferably from 2 to 4, and a mean equivalent molecular weight in the range from 400 to 3000 g/mol, preferably from 1000 to 2500 g/mol.

The polyether alcohols can be prepared by known methods, usually by catalytic addition of alkylene oxides, in particular ethylene oxide and/or propylene oxide, onto H-functional starter substances or by condensation of tetrahydrofuran. H-functional starter substances used are, in particular, polyfunctional alcohols and/or amines. Preference is given to using water, dihydric alcohols, for example ethylene glycol, propylene glycol or butanediols, trihydric alcohols, for example glycerol or trimethylolpropane, and alcohols having a higher functionality, e.g. pentaerythritol, sugar alcohols, for example sucrose, glucose or sorbitol. Preferred amines are aliphatic amines having up to 10 carbon atoms, for example ethylenediamine, diethylenetriamine, propylenediamine and also amino alcohols such as ethanolamine or diethanolamine. As alkylene oxides, preference is given to using ethylene oxide and/or propylene oxide, with an ethylene oxide block frequently being added on at the end of the chain in the case of polyether alcohols used for producing flexible polyurethane foams. As catalysts in the addition reaction of the alkylene oxides, use is made of, in particular, basic compounds among which potassium hydroxide has the greatest industrial importance. If the content of unsaturated constituents in the polyether alcohols is to be low, it is also possible to use dimetal or multimetal cyanide compounds, known as DMC catalysts, as catalysts. It is also possible to use the polyether alcohol used for preparing the prepolymer in the component b).

In particular, bifunctional and/or trifunctional polyether alcohols are used for producing flexible foams and integral foams.

Further compounds which can be used as compound having at least two active hydrogen atoms are polyester polyols which can be prepared, for example, from organic dicarboxylic acids having from 2 to 12 carbon atoms, preferably aliphatic dicarboxylic acids having from 8 to 12 carbon atoms, and polyhydric alcohols, preferably diols, having from 2 to 12 carbon atoms, preferably from 2 to 6 carbon atoms. Possible dicarboxylic acids are, for example: succinic acid, glutaric acid, adipic acid, suberic acid, azelaic acid, sebacic acid, decanedicarboxylic acid, maleic acid, fumaric acid, phthalic acid, isophthalic acid, terephthalic acid and the isomeric naphthalenedicarboxylic acids. Preference is given to using adipic acid. The dicarboxylic acids can be used either individually or in admixture with one another. In place of the free dicarboxylic acids, it is also possible to use the corresponding dicarboxylic acid derivatives, e.g. dicarboxylic esters of alcohols having from 1 to 4 carbon atoms or dicarboxylic anhydrides.

Examples of dihydric and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g. ε-caprolactone, or hydroxycarboxylic acids, e.g. ω-hydroxycaproic acid and hydroxybenzoic acids. Preference is given to using dipropylene glycol.

The hydroxyl number of the polyester alcohols is preferably in the range from 40 to 100 mg KOH/g.

Further suitable polyols are polymer-modified polyols, preferably polymer-modified polyesterols or polyetherols, particularly preferably graft polyetherols or graft polyesterols, in particular graft polyetherols. A polymer-modified polyol is a polymer polyol which usually has a content of preferably thermoplastic polymers of from 5 to 60% by weight, preferably from 10 to 55% by weight, particularly preferably from 30 to 55% by weight and in particular from 40 to 50% by weight.

Polymer polyols are described, for example, in EP-A-250 351, DE 111 394, U.S. Pat. No. 3,304,273, U.S. Pat. No. 3,383,351, U.S. Pat. No. 3,523,093, DE 1 152 536 and DE 1 152 537 and are usually prepared by free-radical polymerization of suitable olefinic monomers, for example styrene, acrylonitrile (meth)acrylates, (meth)acrylic acid and/or acrylamide, in a polyol, preferably polyesterol or polyetherol, which serves as graft base. The side chains are generally formed by transfer of free radicals from growing polymer chains to polyols. The polymer polyol comprises, apart from the graft copolymers, predominantly the homopolymers of the olefins, dispersed in unchanged polyol.

In a preferred embodiment, acrylonitrile, styrene, in particular exclusively styrene, are used as monomers. The monomers are, if appropriate, polymerized in the presence of further monomers, a macromer, a moderator and a free-radical initiator, usually azo or peroxide compounds, in a polyesterol or polyetherol as continuous phase.

If polymer polyol is present in the relatively high molecular weight compound b), this is preferably present together with further polyols, for example polyetherols, polyesterols or mixtures of polyetherols and polyesterols. The proportion of polymer polyol is particularly preferably greater than 5% by weight, based on the total weight of the component (b). The polymer polyols can, for example, be comprised in an amount of from 7 to 90% by weight or from 11 to 80% by weight, based on the total weight of the component b). The polymer polyol is particularly preferably polymer polyesterol or polymer polyetherol.

For the purposes of the invention, the hyperbranched polyester c1) of the AₓB_{y} type used is a hyperbranched polyester c1) of the AₓB_{y} type in which

x is at least 1.1, preferably at least 1.3, in particular at least 2,
y is at least 2.1, preferably at least 2.5, in particular at least 3.

Such hyperbranched polyesters are disclosed, for example, in WO 2005/75563.

In the context of the present invention, “hyperbranched” means that the degree of branching (DB) is from 10 to 100%, preferably from 10 to 99.9%, particularly preferably from 20 to 99%, in particular 20-95%. The term also comprises a dendrimer having a degree of branching of 100%. For the definition of the “degree of branching”, see H. Frey et al., Acta Polym. 1997, 48, 30.

A polyester of the AₓB_{y} type is a condensate of the molecules A and B, where the molecules A have functional groups funct1) and the molecules B have functional groups funct2) which are able to condense with one another. The functionality of the molecules A is x and the functionality of the molecules B is y. An example which may be mentioned is a polyester derived from adipic acid as molecule A (funct1=COOH, x=2) and glycerol as molecule B (funct2=OH; y=3).

Of course, mixtures of various molecules A having the same functional group and identical and/or different functionalities and various molecules B having the same functional group and identical and/or different functionalities can also be used as units A and B, respectively. The functionalities x and y of the mixture are then obtained by averaging.

In particular, the hyperbranched polyesters c1) used according to the invention can be obtained by the following process in which
(u) one or more dicarboxylic acids or one or more derivatives thereof are reacted with one or more at least trifunctional alcohols
   or
(v) one or more tricarboxylic acids or higher polycarboxylic acids or one or more derivatives thereof are reacted with one or more diols,
   if appropriate in the presence of a solvent and optionally in the presence of an inorganic, metal-organic or low molecular weight organic catalyst or an enzyme. Reaction in a solvent is the preferred method of preparation.

For the purposes of the present invention, hyperbranched polyesters c1) are preferably molecularly and structurally nonuniform. They differ from dendrimers in their molecular nonuniformity and can therefore be prepared considerably more easily.

Dicarboxylic acids which can be reacted according to variant (u) include, for example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid and cis- and trans-cyclopentane-1,3-dicarboxylic acid, where the abovementioned dicarboxylic acids may be substituted by one or more radicals selected from among

C₁-C₁₀-alkyl groups, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, isoheptyl, n-octyl, 2-ethylhexyl, n-nonyl and n-decyl,
C₃-C₁₂-cycloalkyl groups, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl;
alkylene groups such as methylene or ethylidene or
C₆-C₁₄-aryl groups, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Examples of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Further dicarboxylic acids which can be reacted according to variant (u) are ethylenically unsaturated acids such as maleic acid and fumaric acid and also aromatic dicarboxylic acids such as phthalic acid, isophthalic acid or terephthalic acid.

Furthermore, it is possible to use mixtures of two or more of the abovementioned representatives.

The dicarboxylic acids can be used either as such or in the form of their derivatives.

Derivatives are preferably
the respective anhydrides in monomeric or polymeric form,
monoalkyl or dialkyl esters, preferably monomethyl or dimethyl esters or the corresponding monoethyl or diethyl esters but also the monoalkyl and dialkyl esters derived from higher alcohols such as n-propanol, isopropanol, n-butanol, isobutanol, tert-butanol, n-pentanol, n-hexanol,
also monovinyl and divinyl esters and
mixed esters, preferably methyl ethyl esters.

In the preferred preparation, it is also possible to use a mixture of a dicarboxylic acid and one or more of its derivatives. It is likewise possible to use a mixture of a plurality of different derivatives of one or more dicarboxylic acids.

Particular preference is given to using succinic acid, glutaric acid, adipic acid, phthalic acid, isophthalic acid, terephthalic acid or their monomethyl or dimethyl esters. Very particular preference is given to using adipic acid.

As at least trifunctional alcohols, it is possible to use, for example: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or di-trimethylolpropane, trimethylolethane, pentaerythritol, diglycerol, triglycerol, polyglycerol or dipentaerythritol; sugar alcohols such as mesoerythritol, threitol, sorbitol, mannitol or mixtures of the above at least trifunctional alcohols. Preference is given to using glycerol, trimethylolpropane, trimethylolethane and pentaerythritol. Tricarboxylic acids or polycarboxylic acids which can be reacted according to variant (v) are, for example, 1,2,4-benzenetricarboxylic acid, 1,3,5-benzenetricarboxylic acid, 1,2,4,5-benzenetetracarboxylic acid and mellitic acid.

Tricarboxylic acids or polycarboxylic acids can be used either as such or else in the form of derivatives in the reaction according to the invention.

Derivatives are preferably
the respective anhydrides in monomeric or polymeric form,
monoalkyl, dialkyl, or trialkyl esters, preferably monomethyl, dimethyl, or trimethyl esters or the corresponding monoethyl, diethyl or triethyl esters but also the monoesters, diesters and triesters derived from higher alcohols such as n-propanol, isopropanol, n-butanol, isobutanol, tert-butanol, n-pentanol, n-hexanol, also monovinyl, divinyl or trivinyl esters,
and also mixed methyl ethyl esters

For the purposes of the present invention, it is also possible to use a mixture of a tri-carboxylic or polycarboxylic acid and one or more of its derivatives. It is likewise possible within the scope of the present invention to use a mixture of a plurality of different derivatives of one or more tricarboxylic or polycarboxylic acids in order to obtain the hyperbranched polyester c1).

As diols for variant (v) of the present invention, use is made of, for example, ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representatives of the above compounds, where n is an integer and n=4 to 25. Here, one or both hydroxyl groups in the abovementioned diols can also be replaced by SH groups. Preference is given to ethylene glycol, propane-1,2-diol and also diethylene glycol, triethylene glycol, dipropylene glycol and tripropylene glycol.

The molar ratio of the molecules A to molecules B in the polyester AₓB_{y} in the variants (u) and (v) is from 4:1 to 1:4, in particular from 2:1 to 1:2.

The at least trifunctional alcohols reacted according to variant (u) of the process can have hydroxyl groups which each have the same reactivity. Preference is also given here to at least trifunctional alcohols whose OH groups initially have the same reactivity but in which a decrease in reactivity, caused by steric or electronic influences, can be induced in the remaining OH groups by reaction with at least one acid group. This is the case, for example, when using trimethylolpropane or pentaerythritol.

However, the at least trifunctional alcohols reacted according to variant (u) can also have hydroxyl groups having at least two chemically different reactivities.

The differing reactivity of the functional groups can be due either to chemical (e.g. primary/secondary/tertiary OH group) or steric causes.

For example, the triol can be an alcohol which has primary and secondary hydroxyl groups, a preferred example is glycerol.

When the reaction according to the invention is carried out according to variant (u), it is possible to use triol or mixtures of triols which can comprise up to 50 mol % (based on the polylol mixture) of bifunctional or monofunctional alcohols, but preference is given to carrying out the reaction in the absence of diols and monofunctional alcohols.

When the reaction according to the invention is carried out according to variant (v), it is possible to use tricarboxylic acids or mixtures thereof which can comprise up to 50 mol %, based on the acid mixture, of bifunctional or monofunctional carboxylic acids, but preference is given to carrying out the reaction in the absence of monocarboxylic or dicarboxylic acids.

The process of the invention is preferably carried out in the absence of solvents or in the presence of a solvent. Suitable solvents are, for example, hydrocarbons such as paraffins or aromatics. Particularly suitable paraffins are n-heptane and cyclohexane. Particularly suitable aromatics are toluene, ortho-xylene, meta-xylene, para-xylene, xylene as an isomer mixture, ethylbenzene, chlorobenzene and ortho- and meta-dichlorobenzene. Further solvents which are very particularly useful in the absence of acid catalysts are: ethers such as dioxane or tetrahydrofuran and ketones such as methyl ethyl ketone and methyl isobutyl ketone.

The amount of solvent added is, according to the invention, at least 0.1% by weight, based on the mass of the starting materials to be reacted, preferably at least 1% by weight and particularly preferably at least 10% by weight. It is possible to use excesses of solvent, for example from 1.01 to 10 times the mass of starting materials to be reacted. Amounts of solvent of more than 100 times the mass of starting materials to be reacted are not advantageous because the reaction rate decreases significantly at significantly lower concentrations of the reactants, which leads to uneconomically long reaction times.

The process preferred according to the invention can be carried out in the presence of a water-withdrawing agent as additive which is added at the beginning of the reaction. Suitable agents of this type are, for example, molecular sieves, in particular molecular sieve 4 Å, MgSO₄ and Na₂SO₄. It is also possible to add further water-withdrawing agent or replace water-withdrawing agent by fresh water-withdrawing agent during the reaction. It is also possible to distil off water or alcohol formed during the reaction and, for example, use a water separator.

The process can be carried out in the absence of acid catalysts. It is preferably carried out in the presence of an inorganic, metal-organic or organic acid catalyst or mixtures of a plurality of inorganic, metal-organic or organic acid catalysts.

For the purposes of the present invention, inorganic acid catalysts are, for example, sulfuric acid, phosphoric acid, phosphonic acid, hypophosphorous acid, aluminum sulfate hydrate, alum, acidic silica gel (pH=6, in particular =5) and acidic aluminum oxide. Furthermore, it is possible to use, for example, aluminum compounds of the general formula Al(OR)₃ and titanates of the general formula Ti(OR)₄ as inorganic acid catalysts, where the radicals R can in each case be identical or different and are selected independently from among

C₁-C₁₀-alkyl radicals, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, isoheptyl, n-octyl, 2-ethylhexyl, n-nonyl or n-decyl,
C₃-C₁₂-cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl.

The radicals R in Al(OR)₃ and Ti(OR)₄ are in each case preferably identical and selected from among isopropyl and 2-ethylhexyl.

Preferred metal-organic acid catalysts are, for example, selected from among dialkyltin oxides R₂SnO, where R is as defined above. A particularly preferred representative of metal-organic acid catalysts is di-n-butyltin oxide, which is commercially available as oxo-tin, or di-n-butyltin dilaurate.

Preferred organic acid catalysts are acidic organic compounds having, for example, phosphate groups, sulfonic acid groups, sulfate groups or phosphonic acid groups. Particular preference is given to sulfonic acids such as para-toluenesulfonic acid. It is also possible to use acid ion exchangers as organic acid catalysts, for example polystyrene resins which comprise sulfonic acid groups and are crosslinked with about 2 mol % of divinylbenzene.

Combinations of two or more of the abovementioned catalysts can also be used. It is also possible to use organic or metal-organic or inorganic catalysts which are present in the form of discrete molecules in immobilized form.

If inorganic, metal-organic or organic acid catalysts are to be used, they are, according to the invention, used in an amount of from 0.1 to 10% by weight, preferably from 0.2 to 2% by weight, of catalyst.

The process for preparing the hyperbranched polyesters c1) is carried out under an inert gas atmosphere, i.e., for example, under carbon dioxide, nitrogen or noble gas, in particular argon.

The process for preparing the hyperbranched polyesters c1) is carried out at temperatures of from 60 to 200° C. It is preferably carried out at temperatures of from 130 to 180° C., in particular up to 150° C. or below. Particular preference is given to maximum temperatures up to 145° C., very particularly preferably up to 135° C.

The pressure conditions in the process for preparing the hyperbranched polyesters c1) are not critical per se. The process can be carried out at a significantly reduced pressure, for example from 10 to 500 mbar. The process for preparing the hyperbranched polyesters c1) can also be carried out at pressures above 500 mbar. For reasons of simplicity, the reaction is preferably carried out at atmospheric pressure, but it is also possible to carry it out under slightly superatmospheric pressure, for example up to 1200 mbar. It can also be carried out under significantly superatmospheric pressure, for example at pressures up to 10 bar. The reaction is preferably carried out at atmospheric pressure.

The reaction time of the process according to the invention is usually from 10 minutes to 25 hours, preferably from 30 minutes to 10 hours and particularly preferably from one to 8 hours.

After the reaction for preparing the hyperbranched polyesters c1) is complete, the hyperbranched polyesters c1) can be isolated easily, for example by filtering off the catalyst and evaporating the filtrate, usually under reduced pressure. Further well-suited work-up methods are precipitation by addition of water and subsequent washing and drying.

Furthermore, the hyperbranched polyester c1) can be prepared in the presence of enzymes or decomposition products of enzymes, as described in DE-A 101 63163.

The dicarboxylic acids reacted to produce the hyperbranched polyesters do not count as organic acid catalysts for the purposes of the present invention.

Preference is given to using lipases or esterases. Well-suited lipases and esterases are Candida cylindracea, Candida lipolytica, Candida rugosa, Candida antarctica, Candida utilis, Chromobacterium viscosum, Geolrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii or esterases of Bacillus spp. and Bacillus thermoglucosidasius. Particular preference is given to Candida antarctica lipase B. The enzymes listed are commercially available, for example from Novozymes Biotech Inc., Denmark.

The enzyme is preferably used in immobilized form, for example on silica gel or Lewatit®. Methods of immobilizing enzymes are known per se, for example from Kurt Faber, “Biotransformations in organic chemistry”, 3rd edition 1997, Springer Verlag, chapter 3.2 “Immobilization”, pages 345-356. Immobilized enzymes are commercially available, for example from Novozymes Biotech Inc., Denmark.

The amount of immobilized enzyme used is from 0.1 to 20% by weight, in particular from 10 to 15% by weight, based on the mass of all the starting materials to be reacted.

The process for preparing the hyperbranched polyester c1) using an enzyme or decomposition products of enzymes is carried out at temperatures above 60° C. It is preferably carried out at temperatures of 100° C. or below. Preference is given to temperatures up to 80° C., very particularly preferably from 62 to 75° C. and even more preferably from 65 to 75° C.

The process for preparing the hyperbranched polyester c1) using an enzyme or decomposition products of enzymes is carried out in the presence of a solvent. Suitable solvents are, for example, hydrocarbons such as paraffins or aromatics. Particularly suitable paraffins are n-heptane and cyclohexane. Particularly suitable aromatics are toluene, ortho-xylene, meta-xylene, para-xylene, xylene as isomer mixture, ethylbenzene, chlorobenzene and ortho- and meta-dichlorobenzene. Further very particularly useful solvents are: ethers such as dioxane or tetrahydrofuran and ketones such as methyl ethyl ketone and methyl isobutyl ketone.

The amount of solvent added is at least 5 parts by weight, based on the mass of the starting materials to be reacted, preferably at least 50 parts by weight and particularly preferably at least 100 parts by weight. Amounts of over 10 000 parts by weight of solvent are undesirable because the reaction rate decreases significantly at significantly lower concentrations, which leads to uneconomically long reaction times.

The process for preparing the hyperbranched polyester c1) using an enzyme or decomposition products of enzymes is carried out at pressures above 500 mbar. The reaction is preferably carried out at atmospheric pressure or slightly superatmospheric pressure, for example up to 1200 mbar. It can also be carried out under significantly superatmospheric pressure, for example at pressures up to 10 bar. The reaction is preferably carried out at atmospheric pressure.

The reaction time in the process for preparing the hyperbranched polyester c1) using an enzyme or decomposition products of enzymes is usually from 4 hours to 6 days, preferably from 5 hours to 5 days and particularly preferably from 8 hours to 4 days.

After the reaction is complete, the hyperbranched polyesters c1) can be isolated, for example by filtering off the enzyme and evaporating the filtrate, usually under reduced pressure. Further well-suited work-up methods are precipitation by addition of water and subsequent washing and drying.

The hyperbranched polyester c1) is preferably a hyperbranched polyester c1) having a number average molecular weight Mₙ of from 100 to 15 000 g/mol, preferably from 200 to 12 000 g/mol and in particular from 500 to 10 000 g/mol, measured by means of GPC calibrated with polymethyl methacrylate (PMMA) standards.

The hyperbranched polyester c) used according to the invention preferably has an OH number of from 0 to 600, preferably from 1 to 500, in particular from 20 to 500, mg KOH/g of polyester in accordance with DIN 53240 and preferably has a COOH number of from 0 to 600, preferably from 1 to 500 and in particular from 2 to 500, mg KOH/g of polyester.

The glass transition temperature T_{g} of the hyperbranched polyester c1) is preferably from −50° C. to 140° C. and in particular from −50 to 100° C. (by means of DSC, in accordance with DIN 53765).

Particular preference is given to hyperbranched polyesters c1) in which at least one OH or COOH number is greater than 0, preferably greater than 0.1 and in particular greater than 0.5.

As hyperbranched polycarbonate c2), it is possible to use all known polycarbonates which have the degree of branching defined above. Hyperbranched polycarbonates c2) preferably have an OH number of from 0 to 600, particularly preferably from 10 to 550 and in particular from 50 to 550 mg, KOH/g of polycarbonate in accordance with DIN 53240, part 2. Such hyperbranched polycarbonates are described, for example, in WO 2005/075565.

Hyperbranched polycarbonates c2) preferably have a number average molecular weight Mₙ of from 100 to 15 000 g/mol, preferably from 200 to 12 000 g/mol and in particular from 500 to 10 000 g/mol, measured by means of GPC calibrated using PMMA standards.

The glass transition temperature T_{g} of hyperbranched polycarbonates c2) is preferably from −80° C. to +140° C., particularly preferably from −60 to 120° C. (by means of DSC, DIN 53765).

In particular, the viscosity at 23° C. in accordance with DIN 53019 is from 50 to 200 000 mPas, in particular from 100 to 150 000 mPas and very particularly preferably from 200 to 100 000 mPas.

The hyperbranched polycarbonate c2) can preferably be obtained by a process which comprises at least the following steps:
aa) reaction of at least one organic carbonate (A) of the general formula R[O(CO)]ₙOR with at least one aliphatic, aliphatic/aromatic or aromatic alcohol (B) which has at least 30H groups with elimination of alcohols ROH to form one or more condensation products (K), where the radicals R are each, independently of one another, a straight-chain or branched aliphatic, aromatic/aliphatic or aromatic hydrocarbon radical having from 1 to 20 carbon atoms and the radicals R can also be joined to one another to form a ring and n is an integer from 1 to 5, or
ab) reaction of phosgene, diphosgene or triphosgene with the abovementioned alcohol (B) with elimination of hydrogen chloride,
   and
b) intermolecular reaction of the condensation products (K) to form a hyperbranched polycarbonate,
   with the ratio of the OH groups to the carbonates in the reaction mixture being selected so that the condensation products (K) on average have either one carbonate group and more than one OH group or one OH group and more than one carbonate group.

As starting material, it is possible to use phosgene, diphosgene or triphosgene, but preference is given to organic carbonates.

The radicals R of the organic carbonates (A) of the general formula RO(CO)ₙOR used as starting material are each, independently of one another, a straight-chain or branched aliphatic, aromatic/aliphatic or aromatic hydrocarbon radical having from 1 to 20 carbon atoms. The two radicals R can also be joined to one another to form a ring. Preference is given to the radicals each being an aliphatic hydrocarbon radical, particularly preferably a straight-chain or branched alkyl radical having from 1 to 5 carbon atoms, or a substituted or unsubstituted phenyl radical.

In particular, use is made of simple carbonates of the formula RO(CO)ₙOR; n is preferably from 1 to 3, in particular 1.

Dialkyl or diaryl carbonates can, for example, be prepared by reaction of aliphatic, araliphatic or aromatic alcohols, preferably monoalcohols, with phosgene. They can also be prepared by oxidative carbonylation of alcohols or phenols by means of CO in the presence of noble metals, oxygen or NOₓ. For methods of preparing diaryl or dialkyl carbonates, see also “Ullmann's Encyclopedia of Industrial Chemistry”, 6th Edition, 2000 Electronic Release, Wiley-VCH publishers.

Examples of suitable carbonates comprise aliphatic, aromatic/aliphatic or aromatic carbonates such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate or didodecyl carbonate.

Examples of carbonates in which n is greater than 1 comprise dialkyl dicarbonates such as di(t-butyl) dicarbonate or dialkyl tricarbonates such as di(t-butyl tricarbonate).

Preference is given to using aliphatic carbonates, in particular ones in which the radicals comprise from 1 to 5 carbon atoms, for example dimethyl carbonate, diethyl carbonate, dipropyl carbonate, dibutyl carbonate or diisobutyl carbonate.

The organic carbonates are reacted with at least one aliphatic alcohol (B) which has at least 3 OH groups or mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl) isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, bis(trimethylolpropane) or sugars such as glucose, trifunctional or higher-functional polyetherols based on trifunctional or higher-functional alcohols and ethylene oxide, propylene oxide or butylene oxide or polyesterols. Among these, glycerol, trimethylolethane, trimethylolpropane, 1,2,4-butanetriol, pentaerythritol and their polyetherols based on ethylene oxide or propylene oxide are particularly preferred.

These polyfunctional alcohols can also be used in admixture with bifunctional alcohols (B′), with the proviso that the mean OH functionality of all alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3, 3-5-trimethylcyclohexane, resorcinol, hydroquinone, 4,4′-dihydroxyphenyl, bis(4-hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, bifunctional polyether polyols based on ethylene oxide, propylene oxide, butylene oxide or mixtures thereof, polytetrahydrofuran, polycaprolactone or polyesterols based on diols and dicarboxylic acids.

The diols serve to make fine adjustments to the properties of the polycarbonates. If bifunctional alcohols are used, the ratio of bifunctional alcohols B′) to the at least trifunctional alcohols (B) will be decided by a person skilled in the art as a function of the desired properties of the polycarbonate. As a rule, the amount of alcohol or alcohols (B′) is from 0 to 50 mol % based on the total amount of all alcohols (B) and (B′). The amount is preferably from 0 to 45 mol %, particularly preferably from 0 to 35 mol % and very particularly preferably from 0 to 30 mol %.

The reaction of phosgene, diphosgene or triphosgene with the alcohol or alcohol mixture generally occurs with elimination of hydrogen chloride, and the reaction of the carbonates with the alcohol or alcohol mixture to form the hyperbranched polycarbonate c2) according to the invention occurs with elimination of the monofunctional alcohol or phenol from the carbonate molecule.

The hyperbranched polycarbonates c2) formed by the process of the invention are terminated with hydroxyl groups and/or carbonate groups after the reaction, i.e. without further modification. They are readily soluble in various solvents, for example in water, alcohols such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate.

For the purposes of the present invention, a hyperbranched polycarbonate c2) is a product which, in addition to the carbonate groups which form the polymer framework, has at least three, preferably at least six, more preferably at least ten, further terminal or lateral functional groups. The functional groups are carbonate groups and/or OH groups. The number of terminal or lateral functional groups is in principle not subject to any upper limit, but products having a very large number of functional groups can have undesirable properties, for example high viscosity or poor solubility. The hyperbranched polycarbonates c2) usually have not more than 500 terminal or lateral functional groups, preferably not more than 100 terminal or lateral functional groups.

In the preparation of the hyperbranched polycarbonates c2), it is necessary to set the ratio of the compounds comprising OH groups to phosgene or carbonate so that the resulting simplest condensation product, hereinafter referred to as condensation product (K), comprises on average either one carbonate group or carbamoyl group and more than one OH group or one OH group and more than one carbonate group or carbamoyl group. The simplest structure of the condensation product (K) of a carbonate (A) and a dialcohol or polyalcohol (B) gives the arrangement XYₙ or XₙY, where X is a carbonate group, Y is a hydroxyl group and n is generally a number from 1 to 6, preferably from 1 to 4, particularly preferably from 1 to 3. The reactive group which results as single group will hereinafter generally be referred to as “focal group”.

For example, when the reaction ratio in the preparation of the simplest condensation product (K) from a carbonate and a dihydric alcohol is 1:1, the result is on average a molecule of the type XY, illustrated by the general formula 1.

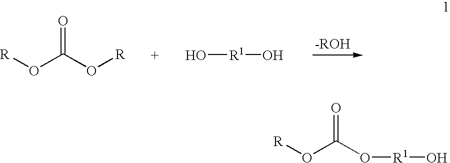

The preparation of the condensation product (K) from a carbonate and a trihydric alcohol at a reaction ratio of 1:1 results on average in a molecule of the type XY₂, illustrated by the general formula 2. The focal group here is a carbonate group.

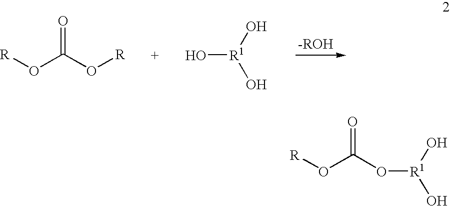

The preparation of the condensation product (K) from a carbonate and a tetrahydric alcohol likewise in a reaction ratio of 1:1 results on average in a molecule of the type

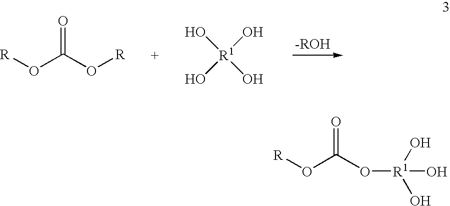

XY₃, illustrated by the general formula 3. The focal group here is a carbonate group. In the formulae 1 to 3, R is as defined above and R¹ is an aliphatic or aromatic radical.

Furthermore, the condensation product (K) can also be prepared, for example, from a carbonate and a trihydric alcohol at a molar reaction ratio of 2:1, illustrated by the general formula 4. This results on average in a molecule of the type X₂Y; the focal group here is an OH group.

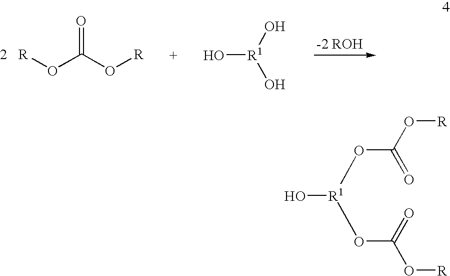

In the formula 4, R and R¹ have the same meanings as in the formulae 1 to 3. If bifunctional compounds, e.g. a dicarbonate or a diol, are additionally added to the components, this effects a lengthening of the chains, as illustrated, for example, in the general formula 5. This again results on average in a molecule of the type XY₂; the

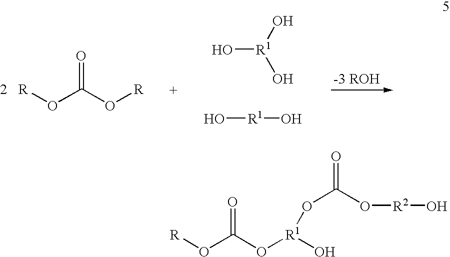

focal group is a carbonate group.

In formula 5, R² is an organic, preferably aliphatic radical, and R and R¹ are as defined above.

It is also possible to use a plurality of condensation products (K) for the synthesis. One possibility here is to use a plurality of alcohols or a plurality of carbonates. Furthermore, mixtures of various condensation products of differing structure can be obtained by selection of the ratio of the alcohols used and the carbonates or the phosgene. This may be illustrated by way of example for the reaction of a carbonate with a trihydric alcohol. If the starting materials are used in a ratio of 1:1, as shown in (II), a molecule XY₂ is obtained. If the starting materials are used in a ratio of 2:1, as shown in (IV), a molecule X₂Y is obtained. At a ratio between 1:1 and 2:1, a mixture of molecules XY₂ and X₂Y is obtained.

According to the invention, the simple condensation products (K) described by way of example in the formulae 1-5 preferably react intermolecularly to form high-functionality polycondensation products, hereinafter referred to as polycondensation products (P). The reaction to form the condensation product (K) and to form the polycondensation product (P) is usually carried out at a temperature of from 0 to 250° C., preferably from 60 to 160° C., in bulk or in solution. Here, it is generally possible to use all solvents which are inert toward the respective starting materials. Preference is given to using organic solvents such as decane, dodecane, benzene, toluene, chlorobenzene, xylene, dimethylformamide, dimethylacetamide or solvent naphtha.

In a preferred embodiment, the condensation reaction is carried out in bulk. The monofunctional alcohol ROH liberated in the reaction or the phenol can be removed from the reaction equilibrium by distillation, if appropriate under reduced pressure, to accelerate the reaction.

If it is to be distilled off, it is normally advisable to use carbonates which liberate alcohols ROH having a boiling point of less than 140° C. in the reaction.

To accelerate the reaction, it is also possible to add catalysts or catalyst mixtures. Suitable catalysts are compounds which catalyze esterification or transesterification reactions, for example alkali metal hydroxides, alkali metal carbonates, alkali metal hydrogencarbonates, preferably of sodium, potassium or cesium, tertiary amines, guanidines, ammonium compounds, phosphonium compounds, organic compounds of aluminum, tin, zinc, titanium, zirconium or bismuth and also double metal cyanide (DMC) catalysts as described, for example, in DE 10138216 or DE 10147712.

Preference is given to using potassium hydroxide, potassium carbonate, potassium hydrogencarbonate, diazabicyclooctane (DABCO), diazabicyclononene (DBN), diazabicycloundecene (DBU), imidazoles such as imidazole, 1-methylimidazole or 1,2-dimethylimidazole, titanium tetrabutoxide, titanium tetraisopropoxide, dibutyltin oxide, dibutyltin dilaurate, tin dioctoate, zirconium acetylacetonate or mixtures thereof.

The catalyst is generally added in an amount of from 50 to 10 000 ppm by weight, preferably from 100 to 5000 ppm by weight, based on the amount of the alcohol or alcohol mixture used.

Furthermore, it is also possible to control the intermolecular polycondensation reaction both by addition of the suitable catalyst and by selection of a suitable temperature. In addition, the average molecular weight of the polymer (P) can be adjusted via the composition of the starting components and via the residence time.

The condensation products (K) and the polycondensation products (P) which have been prepared at elevated temperature are usually stable at room temperature for a relatively long period of time.

Owing to the nature of the condensation products (K), it is possible for polycondensation products (P) having different structures which have branching points but no crosslinks to result from the condensation reaction. Furthermore, the polycondensation products (P) in the ideal case have either a carbonate group as focal group and more than two OH groups or else an OH group as focal group and more than two carbonate groups. The number of reactive groups is determined by the nature of the condensation products (K) used and the degree of polycondensation.

For example, a condensation product (K) of the general formula 2 can react by triple intermolecular condensation to form two different polycondensation products (P) which are shown in the general formulae 6 and 7.

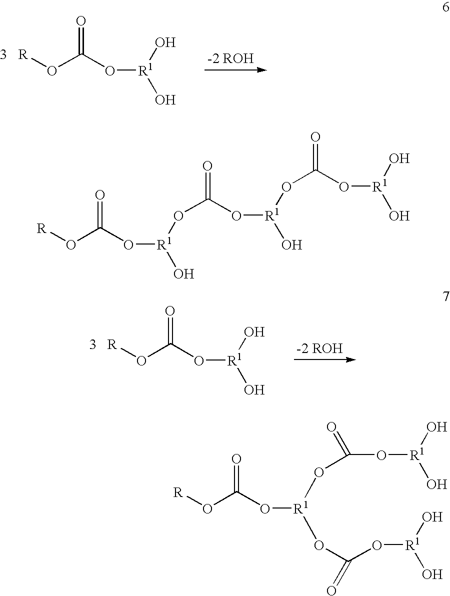

In formula 6 and 7, R and R′ are as defined above.

There are various possible ways of stopping the intermolecular polycondensation reaction. For example, the temperature can be reduced to a range in which the reaction ceases and the product (K) or the polycondensation product (P) is storage-stable.

Furthermore, the catalyst can be deactivated, in the case of basic catalysts by, for example, addition of Lewis acids or protic acids.

In a further embodiment, when a polycondensation product (P) having the desired degree of polycondensation has been formed by the intermolecular reaction of the condensation product (K), the reaction can be stopped by adding a product having groups which are reactive toward the focal group of (P) to the product (P). Thus, in the case of a carbonate group as focal group, it is possible to add, for example, a monoamine, diamine or polyamine. In the case of a hydroxyl group as focal group, it is possible to add, for example, a monoisocyanate, diisocyanate or polyisocyanate, a compound comprising epoxide groups or an acid derivative which is reactive toward OH groups to the product (P).

The preparation of the hyperbranched polycarbonates c2) is usually carried out in a pressure range from 0.1 mbar to 20 bar, preferably from 1 mbar to 5 bar, in reactors or reactor cascades which are operated batchwise, semicontinuously or continuously.

The abovementioned setting of the reaction conditions and, if appropriate, selection of a suitable solvent enable the products according to the invention to be processed further without further purification after they have been prepared.

In a further preferred embodiment, the product is stripped, i.e. freed of low molecular weight, volatile compounds. For this purpose, the catalyst can optionally be deactivated after the desired degree of conversion has been reached and the low molecular weight volatile constituents, e.g. monoalcohols, phenols, carbonates, hydrogen chloride or volatile oligomeric or cyclic compounds can be removed by distillation, if appropriate while passing a gas, preferably nitrogen, carbon dioxide or air, into the product mixture, if appropriate under reduced pressure.

In a further preferred embodiment, the polyesters c1) and/or polycarbonates c2) according to the invention can comprise further functional groups in addition to the functional groups obtained by means of the reaction. The functionalization can be effected during the buildup of the molecular weight or subsequently, i.e. after the actual polycondensation is complete.

If components having further functional groups or functional elements in addition to hydroxyl or carboxyl or carbonate groups are added before or during the buildup of the molecular weight, a polyester or polycarbonate polymer having randomly distributed functions which are different from the hydroxyl groups or carboxyl or carbonate groups is obtained.

Such effects can be achieved, for example, by addition of compounds which bear not only hydroxyl groups, carboxyl or carbonate groups or carbamoyl groups but also further functional groups or functional elements such as mercapto groups, primary, secondary or tertiary amino groups, ether groups, derivatives of carboxylic acids, derivatives of sulfonic acids, derivatives of phosphonic acids, silane groups, siloxane groups, aryl radicals or long-chain alkyl radicals during the polycondensation. To achieve modification by means of carbamate groups, it is possible to use, for example, ethanolamine, propanolamine, isopropanolamine, 2-(butylamino)ethanol, 2-(cyclohexyl-amino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

To achieve modification by mercapto groups, it is possible to use, for example, mercaptoethanol. Tertiary amino groups can be produced, for example, by incorporation of N-methyldiethanolamine, N-methyldipropanolamine or N,N-dimethylethanolamine. Ether groups can be generated, for example, by cocondensation of bifunctional or higher-functional polyetherols. Reaction with long-chain alkanediols allows long-chain alkyl radicals to be introduced, and reaction with alkyl or aryl diisocyanates generates polyesters c1) or polycarbonates c2) comprising alkyl, aryl and urethane groups or urea groups.

Addition of dicarboxylic acids or derivatives thereof, e.g. dimethyl terephthalate, or tricarboxylic acids or derivatives thereof, for example tricarboxylic esters, or hydroxycarboxylic acids or derivatives thereof, for example their esters or cyclic esters such as caprolactone, enables ester groups to be produced.

Subsequent functionalization can be achieved by reacting the hyperbranched polyester c1) obtained or the hyperbranched polycarbonate c2) obtained with a suitable functionalization reagent which can react with the OH and/or carboxyl or carbonate groups or carbamoyl groups of the polyester c1) or the polycarbonate c2) in an additional process step.

Hydroxyl-comprising hyperbranched polyesters c1) or polycarbonates c2) can, for example, be modified by addition of molecules comprising acid groups or isocyanate groups. Polyesters c1) or polycarbonates c2) comprising acid groups can, for example, be obtained by reaction with compounds comprising anhydride groups.

Furthermore, hydroxyl-comprising hyperbranched polyesters c1) or polycarbonates c2) can also be converted into hyperbranched polyester-polyetherols or polycarbonate-polyether polyols by reaction with alkylene oxides, for example ethylene oxide, propylene oxide or butylene oxide.

The proportion of component c) is preferably from 0.01 to 80% by weight, particularly preferably from 0.5 to 50% by weight and in particular from 0.7 to 30% by weight, based on the total weight of the components a) to g). It is also possible, if appropriate, for the total content of hyperbranched polymer to be used for preparing polyisocyanate prepolymers. The component c) is preferably added to a diphenylmethane diisocyanate or derivatives thereof and/or tolylene diisocyanate or derivatives thereof.

Particular preference is given to a flexible polyurethane foam according to the invention in which polyisocyanate a) comprises diphenylmethane diisocyanate or derivatives thereof and component c) comprises hyperbranched polycarbonate c2), in particular a flexible polyurethane foam according to the invention in which exclusively diphenylmethane diisocyanate or derivatives thereof is/are used as polyisocyanate a) and hyperbranched polycarbonate c2) is used as component c).

As chain extenders and/or crosslinkers (d), use is made of substances having a molecular weight of preferably less than 500 g/mol, particularly preferably from 60 to 400 g/mol, with chain extenders having 2 hydrogen atoms which are reactive toward isocyanates and crosslinkers having 3 hydrogen atoms which are reactive toward isocyanate. These can be used individually or in the form of mixtures. Preference is given to using diols and/or triols having molecular weights of less than 400, particularly preferably from 60 to 300 and in particular from 60 to 150. It is possible to use, for example, aliphatic, cycloaliphatic and/or araliphatic diols having from 2 to 14, preferably from 2 to 10, carbon atoms, e.g. ethylene glycol, 1,3-propanediol, 1,10-decanediol, o-, m-, p-dihydroxycyclohexane, diethylene glycol, dipropylene glycol and preferably 1,4-butanediol, 1,6-hexanediol and bis(2-hydroxyethyl)hydroquinone, triols such as 1,2,4-, 1,3,5-trihydroxycyclohexane, glycerol and trimethylolpropane, and low molecular weight hydroxyl-comprising polyalkylene oxides based on ethylene oxide and/or 1,2-propylene oxide and the abovementioned diols and/or triols as starter molecules. Particular preference is given to using monoethylene glycol, 1,4-butanediol and/or glycerol as chain extenders (d).

If chain extenders, crosslinkers or mixtures thereof are employed, they are advantageously used in amounts of from 1 to 60% by weight, preferably from 1.5 to 50% by weight and in particular from 2 to 40% by weight, based on the weight of the components (b) and (d).

As catalysts (e) for producing the polyurethane foams, preference is given to using compounds which strongly accelerate the reaction of the hydroxyl-comprising compounds of the components (b), (c) and, if appropriate, (d) with the polyisocyanates (a). Examples which may be mentioned are amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethyl-butanediamine, N,N,N′,N′-tetramethylhexanediamine, pentamethyldiethylenetriamine, bis(dimethylaminoethyl)ether, bis(dimethylaminopropyl)urea, dimethylpiperazine, 1,2-dimethylimidazole, 1-azabicyclo[3.3.0]octane and preferably 1,4-diazabicyclo[2.2.2]-octane and alkanolamine compounds such as triethanolamine, triisopropanolamine, N-methyldiethanolamine and N-ethyldiethanolamine and dimethylethanolamine. Further possible catalysts are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or mixtures thereof. The organic metal compounds can be used either alone or preferably in combination with strongly basic amines. If the component (b) is an ester, preference is given to using exclusively amine catalysts.

Preference is given to using from 0.001 to 5% by weight, in particular from 0.05 to 2% by weight, of catalyst or catalyst combination, based on the weight of the component (b).

Furthermore, blowing agents (f) are present in the production of polyurethane foams. As blowing agents (f), it is possible to use chemically acting blowing agents and/or physically acting compounds. For the purposes of the present invention, chemical blowing agents are compounds which form gaseous products, for example water or formic acid, by reaction with isocyanate. Physical blowing agents are compounds which are dissolved or emulsified in the starting materials and vaporize under the conditions of polyurethane formation. These are, for example, hydrocarbons, halogenated hydrocarbons and other compounds, for example perfluorinated alkanes such as perfluorohexane, chlorofluorocarbons and ethers, esters, ketones and/or acetals, for example (cyclo)aliphatic hydrocarbons having from 4 to 8 carbon atoms, fluorinated hydrocarbons such as Solkane® 365 mfc, or gases such as carbon dioxide. In a preferred embodiment, a mixture of these blowing agents comprising water is used as blowing agent. If no water is used as blowing agent, preference is given to using exclusively physical blowing agents.

In a preferred embodiment, the content of physical blowing agents (f) is in the range from 1 to 20% by weight, in particular from 5 to 20% by weight, and the amount of water is preferably in the range from 0.5 to 10% by weight, in particular from 1 to 5% by weight. Preference is given to using carbon dioxide as blowing agent (f), and this is introduced either on-line, i.e. directly at the mixing head, or via the stock tank in the case of batch process.

As auxiliaries and/or additives (g), use is made of, for example, surface-active substances, foam stabilizers, cell regulators, external and internal mold release agents, fillers, pigments, hydrolysis inhibitors and fungistatic and bacteristatic substances.

In the industrial production of polyurethane foams, it is customary to combine the compounds having at least two active hydrogen atoms b) and one or more of the starting materials c) to g), if they have not already been used for preparing polyisocyanate prepolymers, to form a polyol component before the reaction with the polyisocyanate a).

Further information on the starting materials used may be found, for example, in Kunststoffhandbuch, volume 7, Polyurethane, edited by Günter Oertel, Carl-Hanser-Verlag, Munich, 3rd edition 1993.

To produce the polyurethanes of the invention, the organic polyisocyanates are reacted with the compounds having at least two active hydrogen atoms in the presence of the blowing agents, catalysts and auxiliaries and/or additives mentioned (polyol component).

In the production of the composite material according to the invention, the polyisocyanates (a), the relatively high molecular weight compounds having at least two reactive hydrogen atoms (b), hyperbranched polyester c1) of the AₓB_{y} type, where x is at least 1.1 and y is at least 2.1, and/or hyperbranched polycarbonate c2) and, if appropriate, the chain extenders and/or crosslinkers (d) are generally reacted in such amounts that the equivalence ratio of NCO groups of the polyisocyanates (a) to the sum of the reactive hydrogen atoms of the components (b), (c) and, if appropriate, (d) and (f) is 0.7-1.25:1, preferably 0.80-1.15:1. A ratio of 1:1 corresponds to an isocyanate index of 100.

The polyurethane foams are preferably produced by the one-shot process, for example using the high-pressure or low-pressure technique. The foams can be produced in open or closed metallic molds or by continuous application of the reaction mixture to conveyor belts so as to produce slabstock foams.

It is particularly advantageous to employ the two-component process in which, as mentioned above, a polyol component is prepared and foamed with polyisocyanate a). The components are preferably mixed at a temperature in the range from 15 to 120° C., preferably from 20 to 80° C., and introduced into the mold or applied to the conveyor belt. The temperature in the mold is usually in the range from 15 to 120° C., preferably from 30 to 80° C.

Flexible polyurethane foams according to the invention are preferably used as upholstery for furniture and mattresses, orthopedic products, for example cushions, for upholstery in the automobile sector, e.g. armrests, headrests and in particular car seats, and at given hardnesses display improved elasticity values. Furthermore, flexible polyurethane foams according to the invention have, especially when polycarbonates are used as hyperbranched polymer c), particularly advantageous burning properties.

A further advantage of the polyurethanes of the invention is excellent damping behavior. To demonstrate this, the damping behavior is determined by exciting the sample foam having a thickness of 10 cm under standard conditions of temperature and humidity with 50 kg in a frequency range of 2-20 Hz at an excitation amplitude of +/−1 mm. The ratio of the measured deflection of the upper side of the foam to the excitation, in each case in mm, gives the transmission. The frequency at which the maximum deflection is measured is referred to as the resonance frequency. Since the human body reacts particularly sensitively to vibrations in a frequency range of 2-20 Hz, the transmission in this range, particularly in the region of the resonance frequency, should be very low.

The invention is illustrated below by examples of the use of hyperbranched polyols in flexible foams.

In the examples, the foam density was determined in accordance with DIN EN ISO 845. Furthermore, the compressive strength was determined in accordance with DIN EN ISO 3386 and the rebound resilience was determined in accordance with DIN 53573.

In the examples, the following starting materials were used:
Polyol 1: Graft polyol based on styrene-acrylonitrile and having a solids content of 45% in a polyoxypropylene-polyoxyethylene polyol and having an OH number of 20 mg KOH/g and a mean functionality of 2.7.
Polyol 2: Polyoxypropylene-polyoxyethylene polyol having an OH number of 35 mg KOH/g and a mean functionality of 2.7.
Polyol 3: Polyoxypropylene-polyoxyethylene polyol having an OH number of 42 mg KOH/g and a mean functionality of 2.6.
Polyol 4: Polyoxyethylene polyol having an OH number of 525 mg KOH/g and a mean functionality of 3.
DEOA: Diethanolamine
HB Polyol 1: Hyperbranched polycarbonate derived from diethyl carbonate, polypropylene oxide triol and partly benzoic acid cap and having an OH number of 75 mg KOH/g.
HB Polyol 2: Hyperbranched polyester derived from adipic acid and glycerol and having an OH number of 360 mg KOH/g.
HB Polyol 3: Hyperbranched polycarbonate derived from diethyl carbonate and polyoxyethylene triol and having an OH number of 266 mg KOH/g.
HB Polyol 4: Boltorn P500, from Perstorp, dendritic polyester polyol based on 2,2-dimethylolpropionic acid and having an OH number of 602 mg KOH/g.
Catalysis: Amine catalysis
Isocyanate 1: Tolylene diisocyanate (Lupranat T 80, BASF AG) having an NCO content of 48.3% by weight.
Isocyanate 2: Mixture of 20% by weight of polymeric diphenylmethane diisocyanate (Lupranat M20), 45% by weight of diphenyl methane 4,4′-diisocyanate and 35% by weight of diphenylmethane 2,4-diisocyanate having a mean NCO content of 33.3% by weight.
Here, the hyperbranched polyols HB Polyol 1, HB Polyol 2 and HB Polyol 3 were obtained as follows:

### HB Polyol 1:

In a 4 l flask provided with stirrer, internal thermometer and reflux condenser, diethyl carbonate (879 g, 7.44 mol) and a triol (2000 g, 4.65 mol) which had been obtained beforehand by propoxylation of trimethylolpropane with 5.2 propylene oxide units were reacted with one another in the presence of potassium hydroxide (0.4 g) at about 140° C. under atmospheric pressure under a gentle stream of nitrogen. Here, ethanol was continually formed as condensation by-product in the reaction mixture during the course of the reaction, so that the boiling point of the reaction mixture decreased to 115° C. over a period of 1.5 hours. The mixture was subsequently briefly cooled to below 100° C. and ethyl benzoate (233 g, 1.55 mol) was added. The reaction mixture was then once again heated at about 115° C. under reflux, resulting in, as described above, the boiling point decreasing further during the course of the reaction. After a further 4 hours, the boiling point had dropped to about 105° C. and remained constant at this value. The reflux condenser was subsequently replaced by a distillation apparatus comprising a 20 cm packed column, a descending condenser and a receiver and the ethanol formed in the reaction was continuously distilled off. After a total of about 665 g of ethanol had been removed, corresponding to a total conversion based on ethanol of about 90%, the reaction mixture was cooled to 100° C. and 85% strength phosphoric acid (0.4 g) was added to neutralize the potassium hydroxide until the pH was less than 7. The mixture was stirred at 100° C. for 1 hour. The reaction apparatus was subsequently provided with a gas inlet tube and the mixture was stripped by means of nitrogen for about 3 hours. This removed further residual ethanol and low molecular weight components (total of about 25 g).

The product was subsequently cooled and analyzed.

The OH number was found to be 75 mg KOH/g, and the molecular weights were determined by means of GPC (eluent=dimethylacetamide (DMAC), calibration=PMMA) and found to be Mₙ=1800 g/mol, M_{w}=15400 g/mol.

### HB Polyol 2:

In a 2 l flask provided with stirrer, internal thermometer, a capillary for the introduction of nitrogen and a descending condenser with vacuum connection, adipic acid (877 g, 6.0 mol) and glycerol (461 g, 5.0 mol) were reacted with one another in the presence of di-n-butyltin oxide (Fascat®) (3 g) at 140° C. at atmospheric pressure under a gentle stream of nitrogen, with water of condensation formed being separated off.

After a reaction time of 4 hours, the pressure was reduced to 50 mbar and condensation was continued until an acid number of 100 mg KOH/g had been reached. Atmospheric pressure was then established by introduction of nitrogen, 382 g of glycerol were added and polycondensation was carried out again at 140° C. under reduced pressure until an acid number of 19 mg KOH/g had been reached. The product was subsequently cooled and analyzed.

The viscosity was 5000 mPas at 75° C., and the OH number was found to be 360 mg KOH/g.

### HB Polyol 3:

In a 4 l flask provided with stirrer, internal thermometer and reflux condenser, diethyl carbonate (762 g, 6.45 mol) and a triol (2000 g, 6.45 mol) which had been obtained beforehand by ethoxylation of glycerol with 4.9 ethylene oxide units were reacted with one another in the presence of potassium hydroxide (0.4 g) at about 120° C. under atmospheric pressure under a gentle stream of nitrogen. Here, ethanol was continually formed as condensation by-product in the reaction mixture during the course of the reaction, so that the boiling point of the reaction mixture decreased to 105° C. over a period of 1 hour. When the boiling point remained constant, the reflux condenser was subsequently replaced by a distillation apparatus comprising a 20 cm packed column, a descending condenser and a receiver and the ethanol formed in the reaction was continuously distilled off. After a total of about 480 g of ethanol had been removed, corresponding to a total conversion based on ethanol of about 80%, the reaction mixture was cooled to 100° C. and 85% strength phosphoric acid (1.2 g) was added to neutralize the potassium hydroxide until the pH was less than 7. The mixture was stirred at 100° C. for 1 hour. The reaction apparatus was subsequently provided with a gas inlet tube and the mixture was stripped by means of nitrogen for about 3 hours. This removed further residual ethanol and low molecular weight components (total of about 8 g).

The product was subsequently cooled and analyzed.

The OH number was found to be 266 mg KOH/g, and the molecular weights were determined by means of GPC (eluent=dimethylacetamide (DMAC), calibration ═PMMA) and found to be Mₙ=1500 g/mol, M_{w}=2800 g/mol.

TDI slabstock foams were produced as shown in table 1 and tested to determine their hardness and elasticity.

pbm is parts by mass, and Index is the isocyanate index.

As burning test, the test in accordance with Cal TB 117 A, a burning test for furniture/mattresses, was carried out.

TABLE 1

| | | Comparative | | Comparative | | Comparative |
|---|---|---|---|---|---|---|
| | | example 1 | Example 1 | example 2 | Example 2 | example 3 |
| Formulation | | | | | | |
| Polyol 1 | pbm | 33.3 | 16.3 | 16.3 | 33.3 | 33.3 |
| Polyol 2 | pbm | 66.7 | 66.7 | 66.7 | 66.7 | 66.7 |
| Diethanolamine | pbm | 1.49 | 1.49 | 1.49 | 1.49 | 1.49 |
| HB Polyol 1 | pbm | — | 17 | — | — | — |
| HB Polyol 2 | pbm | — | — | — | 4 | — |
| HB Polyol 4 | | — | — | 17 | — | 4 |
| Water | pbm | 1.63 | 1.63 | 1.63 | 1.63 | 1.63 |
| Stabilizer | pbm | 0.5 | 0.5 | 0.5 | 0.5 | 0.5 |
| Catalysis | pbm | 0.42 | 0.42 | 0.42 | 0.42 | 0.42 |
| Isocyanate 1 | | | | | | |
| | Index | 105 | 105 | 105 | 105 | 105 |
| Properties | | | | | | |
| Foam density, | kg/m³ | 39.2 | 39.3 | none | 40.8 | 37.6 |
| core | | | | | | |
| Compressive | kPa | 4.4 | 5.2 | stable | 4.7 | 5.1 |
| strength 40% | | | | | | |
| Rebound | % | 58 | 64 | foam | 63 | 42 |
| resilience | | | | | | |
| Burning test | | not passed | — | — | passed | — |

It can be seen from table 1 that an improvement both in the compressive strength at 40% compression and the rebound resilience is achieved by addition of polyesters according to the invention and of polycarbonates according to the invention. In contrast, the use of HB Polyol 4 at lower concentrations leads to a deterioration in the rebound resilience compared to comparative example 1 without addition of hyperbranched polymer, and at a higher concentration of HB Polyol 4, no stable foam is obtained. The burning test is passed by a foam as described in example 2, while a foam without hyperbranched polyol as described in comparative example 1 does not pass this test.

MDI molded foams were produced as shown in table 2 and were tested to determine their hardness and elasticity.

TABLE 2

| | | Com- | | | Com- |
|---|---|---|---|---|---|
| | | parative | | | parative |
| | | exam- | | Exam- | exam- |
| | | ple 4 | Example 3 | ple 4 | ple 5 |
| Formulation | | | | | |
| Polyol 2 | pbm | 76.05 | 72.05 | 72.05 | 72.05 |
| Polyol 1 | pbm | 15 | 15 | 15 | 15 |
| Polyol 3 | pbm | 4 | 4 | 4 | 4 |
| DEOA | pbm | 0.85 | 0.85 | 0.85 | 0.85 |
| HB Polyol 3 | pbm | — | 4 | — | — |
| HB Polyol 2 | pbm | — | — | 4 | — |
| HB Polyol 4 | | — | — | — | 4 |
| Water | pbm | 2.6 | 2.6 | 2.6 | 2.6 |
| Stabilizer | pbm | 0.5 | 0.5 | 0.5 | 0.5 |
| Catalyst system 2 | pbm | 1.0 | 1.0 | 1.0 | 1.0 |
| Isocyanate 2 | | | | | |
| | Index | 95 | 95 | 95 | 95 |
| Properties | | | | | |
| Foam density, core | kg/m³ | 60.0 | 59.5 | 60.6 | 60.9 |
| Compressive strength | kPa | 5.4 | 6.3 | 7.3 | 6.5 |
| 40% | | | | | |
| Rebound resilience | % | 64 | 66 | 64 | 64 |
| Nature of the surface | | + | + | + | − |

The nature of the surface was assessed with the naked eye. + denotes a defect-free surface; − denotes a surface with defects

Here, the use of hyperbranched polymer leads to an improvement in the compressive strength at constant rebound resilience, but surface defects occur when HB Polyol 4 is used. A particularly pronounced improvement in the hardness is achieved by addition of HB Polyol 2.

MDI molded foams were produced as shown in table 3 and tested to determine their damping properties. Here, polyol 4 which is usually used for improving the elasticity was used as comparison.

TABLE 3

| | | Comparative | |
|---|---|---|---|
| | | example 6 | Example 5 |
| Formulation | | | |
| Polyol 2 | pbm | 66.05 | 76.05 |
| Polyol 1 | pbm | 15 | 7.5 |
| Polyol 3 | pbm | 4.00 | 4.00 |
| DEOA | pbm | 0.85 | 0.85 |
| Polyol 4 | pbm | 10 | — |
| HB Polyol 1 | pbm | — | 7.5 |
| Water | pbm | 2.6 | 2.6 |
| Stabilizer | pbm | 0.5 | 0.5 |
| Catalyst system 2 | pbm | 1.0 | 1.0 |
| Isocyanate 2 | Index | 95 | 95 |
| Properties | | | |
| Foam density, core | kg/m³ | 60.6 | 61.2 |
| Compressive | kPa | 5.9 | 5.7 |
| strength 40% | | | |
| Rebound resilience | % | 64 | 61 |
| Resonance | Hz | 4.44 | 4.36 |
| frequency | | | |
| Transmission | | 6.24 | 4.74 |

Molded foams according to the invention display significantly lower values for the transmission at the same resonance frequency and thus display improved damping.

1-22. (canceled)

23. A flexible polyurethane foam obtainable by mixing
a) polyisocyanate with
b) at least one relatively high molecular weight compound having at least two reactive hydrogen atoms,
c) at least one of a hyperbranched polyester c1) represented by AₓB_{y} where x is at least 11.1 and y is at least 2.1, and hyperbranched polycarbonate c2),
e) a catalyst, and
f) a blowing agent.

24. The flexible polyurethane foam according to claim 23, wherein the component b) comprises a polymer-modified polyol.

25. The flexible polyurethane foam according to claim 24, wherein the polymer-modified polyol is a graft polyetherol or a graft polyesterol having a content of thermoplastic polymer of from 5 to 60% by weight, based on the total weight of the polymer-modified polyol.

26. The flexible polyurethane foam according to claim 24, wherein the component b) comprises more than 5% by weight, based on the total weight of the component b), of polymer-modified polyol.

27. The flexible polyurethane foam according to claim 23, wherein the hyperbranched polyester c1) and the hyperbranched polycarbonate c2) each have a mean degree of branching of from 10 to 100%.

28. The flexible polyurethane foam according to claim 23, wherein the proportion of the hyperbranched polyester c1) and the hyperbranched polycarbonate c2) together is from 0.01 to 50% by weight, based on the total weight of the components a) to g).

29. The flexible polyurethane foam according to claim 23, wherein the hyperbranched polyester c1) and the hyperbranched polycarbonate c2) each have an OH number of from 0 to 600 mg KOH/g.

30. The flexible polyurethane foam according to claim 23, wherein the hyperbranched polyester c1) has a number average molecular weight Mn of from 100 to 15 000 g/mol.

31. The flexible polyurethane foam according to claim 23, wherein the hyperbranched polyester c1) has a COOH number in accordance with DIN 53240 of from 0 to 600 mg KOH/g of polyester.

32. The flexible polyurethane foam according to claim 23, wherein the hyperbranched polyester c1) can be obtained by
a) reacting one or more dicarboxylic acids or one or more derivatives thereof with one or more at least trifunctional alcohols
or
b) reacting one or more tricarboxylic acids or higher polycarboxylic acids or one or more derivatives thereof with one or more diols,
in each case if appropriate in the presence of a solvent and optionally in the presence of an inorganic, metal-organic or organic acid catalyst or an enzyme.

33. The flexible polyurethane foam according to claim 32, wherein the hyperbranched polyester c1) can be obtained by proceeding according to a) and wherein an at least trifunctional alcohol which has hydroxyl groups having at least two chemically different reactivities is reacted.

34. The flexible polyurethane foam according to claim 32, wherein the hyperbranched polyester c1) can be obtained by proceeding according to a) and wherein an at least trifunctional alcohol which has hydroxyl groups which each have a chemically identical reactivity is reacted.

35. The flexible polyurethane foam according to claim 32, wherein the hyperbranched polyester c1) can be obtained by proceeding according to b) and wherein an at least trifunctional alcohol which has hydroxyl groups which each have a chemically identical reactivity is reacted.

36. The flexible polyurethane foam according to claim 32, wherein the hyperbranched polyester c1) can be obtained by proceeding according to b) and wherein at least one tricarboxylic acid or polycarboxylic acid which has carboxyl groups of at least two different reactivities is reacted.

37. The flexible polyurethane foam according to claim 23, wherein the hyperbranched polycarbonate c2) has a number average molecular weight Mₙ of from 100 to 15 000 g/mol.

38. The flexible polyurethane foam according to claim 23, wherein the hyperbranched polycarbonate c2) can be obtained by a process which comprises:
aa) reaction of at least one organic carbonate (A) of formula R[O(CO)]ₙOR with at least one aliphatic, aliphatic/aromatic or aromatic alcohol (B) which has at least 3 OH groups with elimination of alcohols ROH to form one or more condensation products (K), where the radicals R are each, independently of one another, a straight-chain or branched aliphatic, aromatic/aliphatic or aromatic hydrocarbon radical having from 1 to 20 carbon atoms and the radicals R can also be joined to one another to form a ring and n is an integer from 1 to 5, or
ab) reaction of phosgene, diphosgene or triphosgene with the abovementioned alcohol (B) with elimination of hydrogen chloride, and
b) intermolecular reaction of the condensation products (K) to form a hyperbranched polycarbonate c2),
with the ratio of the OH groups to the carbonates in the reaction mixture selected so that the condensation products (K) on average have either one carbonate group and more than one OH group or one OH group and more than one carbonate group.

39. The flexible polyurethane foam according to claim 38, wherein the reaction mixture further comprises at least one alcohol (B′) having two OH groups, with the proviso that the mean OH functionality of all alcohols used for preparing the hyperbranched polycarbonate c2) together is greater than 2.

40. The flexible polyurethane foam according to claim 32, wherein the hyperbranched polyester c1) obtained, the hyperbranched polycarbonate obtained, or combination thereof, is reacted with a functionalization reagent which can react with at least one of the OH groups, the carboxyl groups, and the carbonate groups of the polyester, the polycarbonate, or a combination thereof, in an additional process step c.

41. The flexible polyurethane foam according to claim 32, wherein the hyperbranched polyester c1) obtained or the hyperbranched polycarbonate c2) obtained is reacted with a functionalization reagent which has further functional groups or functional elements in addition to OH groups, carboxyl groups or carbonate groups and can react with at least one of the OH groups and the carboxyl, or carbonate groups, or carbamoyl groups of the polyester c1) or the polycarbonate c2) in an additional process step.

42. The flexible polyurethane foam according to claim 23, wherein the hyperbranched polyester c1), the hyperbranched polycarbonate c2), or a combination thereof, is reacted completely or partially with isocyanate a) to form the isocyanate prepolymer before the production of the flexible polyurethane foam.

43. A process for producing flexible polyurethane foams, wherein
a) polyisocyanate is mixed with
b) at least one relatively high molecular weight compound having at least two reactive hydrogen atoms,
c) at least one of a hyperbranched polyester c1) represented by AₓB_{y}, where x is at least 1.1 and y is at least 2.1, and a hyperbranched polycarbonate c2),
e) a catalyst, and
f) a blowing agent, and
the mixture is reacted to form the flexible polyurethane foam.

44. The process according to claim 43, wherein at least one of a low molecular weight chain extender, a low molecular weight crosslinker, and an additional additive is further mixed said polyisocyanate.

45. The flexible polyurethane foam according to claim 23, wherein at least one of a low molecular weight chain extender, a low molecular weight crosslinker, and an additional additive is present during said mixing.

46. The flexible polyurethane foam according to claim 32, wherein at least one of a) and b) occurs in the presence of a solvent, in the presence of an inorganic, metal-organic or organic acid catalyst, or in the presence of an enzyme.

47. A process for producing flexible polyurethane foam according to claim 23, comprising mixing
a) polyisocyanate
b) at least one relatively high molecular weight compound having at least two reactive hydrogen atoms,
c) at least one of a hyperbranched polyester c1) represented by AₓB_{y} where x is at least 1.1 and y is at least 2.1, and a hyperbranched polycarbonate c2),
e) a catalyst, and
f) a blowing agent, and
reacting the mixture to form the flexible polyurethane foam.

48. A process of making a furniture, a mattress, a cushion, an orthopedic product, a car seat, a headrest, an armrest, or an automobile carpet comprising molding the flexible polyurethane foam according to claim 23 into the form of a mattress, a cushion, an orthopedic product, a car seat, a headrest, an armrest, or an automobile carpet.
